(19) United States
(12) Patent Application Publication
(10) Pub. No.: US 2025/0137422 A1
(43) Pub. Date: May 1, 2025

(54) SYSTEMS AND METHODS FOR VAPORIZATION OF A LIQUID

(71) Applicant: BENNAMANN SERVICES LTD, Newquay, Cornwall (GB)

(72) Inventors: Thomas William BRADSHAW, Oxon (GB); Daniel Grant MCKELVEY, Cornwall (GB); Duncan Stuart GLASBY, Cornwall (GB); Richard Alexander Baker, Cornwall (GB); Luke James Mann, Cornwall (GB)

(73) Assignee: BENNAMANN SERVICES LTD, Newquay, Cornwall (GB)

(21) Appl. No.: 18/838,732

(22) PCT Filed: Feb. 16, 2023
(86) PCT No.: PCT/IB2023/051417

§ 371 Date: Aug. 15, 2024

Related U.S. Application Data
(60) Provisional application No. 63/311,338, filed on Feb. 17, 2022.

(51) Int. Cl. F02M 21/06; F02M 21/02

(52) U.S. Cl. CPC F02M 21/06; F02M 21/0206; F02M 21/0209; F02M 21/0221

(57) ABSTRACT

Methods and devices for vaporization with a device comprising a liquid input, a gas output, and one or more plates arranged below the liquid input. The one or more plates are configured to receive liquid in droplet form from the liquid input and generate gas by vaporizing the droplets, and the generated gas exits the device via the gas output. The device may include a conduit, such as a pipe carrying a fluid such as engine coolant or other heat source, where the one or more plates are mounted on the conduit or heat source.

### FIELD OF THE DISCLOSURE

This disclosure relates generally to vaporization of a liquid, and in particular, vaporization of a cryogenically stored liquid for use as a fuel and related fuel delivery systems and methods.

### INTRODUCTION

Cryogenically stored materials can be used as fuel for an engine. For example, WO 2019/102357 to Mann et al. is titled “Liquid Methane Storage and Fuel Delivery System” and describes the cryogenic storage of methane and its delivery as fuel. However, the use of such materials as a fuel for engines and other power generation systems can present several technical challenges as compared to conventional, non-cryogenic liquid fuels such as diesel, gasoline, and butane. And more generally, there are challenges for efficient and effective heat exchange when vaporizing liquids from a low temperature. For instance, there may be difficulties with respect to temperature control of the fuel or other vapor, icing, and regulation of inter-related components.

Accordingly, there remains a need for improved vaporization devices and methods, as well as associated heat exchangers and fuel delivery systems and methods.

### SUMMARY

According to embodiments, a vaporization device is provided that comprises a liquid input, a gas output, and one or more plates arranged below the liquid input. In some embodiments, the one or more plates are configured to receive liquid from the liquid input and generate gas by vaporizing the liquid, and the generated gas exits the device via the gas output (e.g., via a vent comprising one-way valve to prevent air ingress at the output). In certain aspects, the liquid input is configured to generate droplets of liquid. The droplets may be formed, for example, either by a small nozzle or by the liquid stream from the liquid input hitting the first plate, where the rapid expansion of the liquid hitting the first plate will generate highly mobile droplets which rapidly move down the vaporizer. The plates can be arranged to receive the liquid input in droplet form. The device may further include a conduit, such as a pipe carrying a fluid such as engine coolant, or other heat source, and in some embodiments the one or more plates are mounted on (or otherwise physically attached to) the conduit or heat source. This may be, for example, a radial arrangement.

According to embodiments, a device comprises: an input; a central conduit; and vaporization means for generating an output gas from liquid received from the input, wherein the vaporization means are mounted on the central conduit and configured to receive heat from the central conduit. The device may further comprise an output for the generated gas.

According to embodiments a system comprises a vaporizer and a heat exchanger, where a first input of the heat exchanger is coupled to the output of the vaporizer. The first input of the heat exchanger can be configured to receive gas output from the vaporizer. In certain aspects, the system includes a container of process liquid connected to a first input of the vaporizer, such as a cryogenic storage tank. In certain aspects, the output of the system may be an engine. For instance, embodiments may include a fuel delivery system.

According to embodiments, a gas processing and/or fuel delivery method comprises: vaporizing a liquid to generate a first gas; and providing at least a first portion of the generated first gas to the input of a heat exchanger to form heated gas. The method may further comprise mixing a second portion of the generated first gas with the heated gas to form a mixed gas (e.g., at a desired temperature), and providing the mixed gas to an engine as fuel. In certain aspects, the method may be a method of operating a vehicle.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIGS. 1A and 1B illustrate a system according to some embodiments.

FIGS. 2A and 2B illustrate temperature variations through devices.

FIG. 3 illustrates a device according to some embodiments.

FIGS. 4A and 4B illustrate plate designs according to some embodiments.

FIG. 5 is a block diagram of a control apparatus according to some embodiments.

FIG. 6 is a flow diagram illustrating a method according to some embodiments.

FIG. 7 is a flow diagram illustrating a method according to some embodiments.

FIG. 8 is a fuel delivery system according to some embodiments.

FIGS. 9 and 10A-10D illustrate storage tanks according to some embodiments.

### DETAILED DESCRIPTION

In many processes a liquid is turned into a vapor, including when using certain materials as fuels, as well as cleaning or purification processes, or transport or electricity generation. Additionally, it may further be necessary to vaporize, or otherwise obtain, gaseous material at a desired temperature. This could be obtained, for instance, from methane or hydrogen. In certain aspects, there may be two components to this: (i) conversion of the liquid into a vapor at a constant (and/or non-target) temperature, where the latent heat of vaporization is added to the liquid, thereby turning it into a vapor; and (ii) heating of the cold vapor to a target temperature (e.g., in a heat exchanger), which may require the addition of heat. According to embodiments, a process liquid is admitted to a vaporizer that contains a hot source, which converts the liquid to a vapor. A fraction of the cold vapor is then heated in a heat exchanger and mixed with the cold stream (e.g., using one or more control valves) to obtain a mixed stream at a desired flow and temperature. In certain aspects, this method may be especially convenient if the temperature of a fluid or other material used for heat exchange is variable, as waste heat can be used. In some embodiments, the use of the vaporizer reduces the risk of a warming fluid in the heat exchanger freezing.

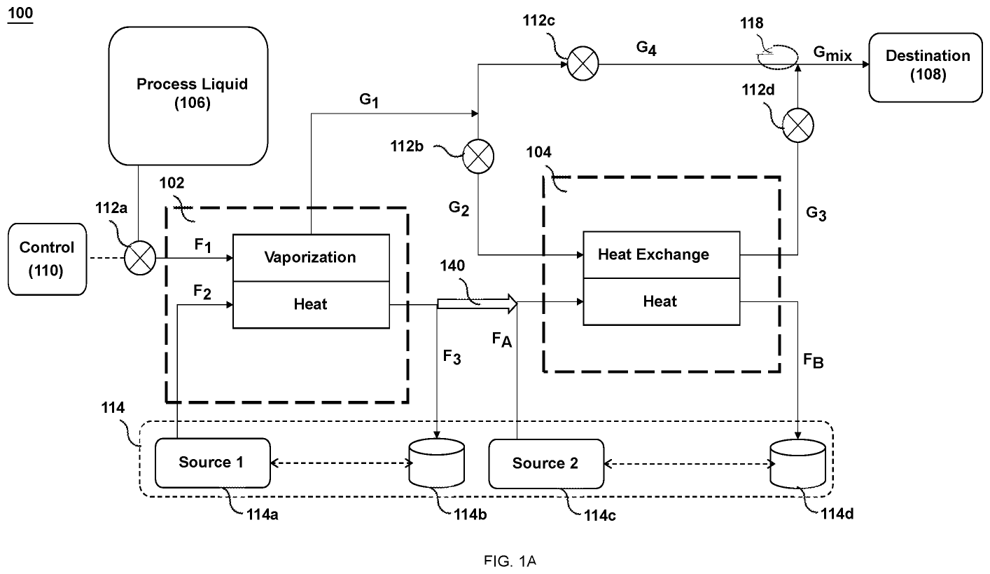

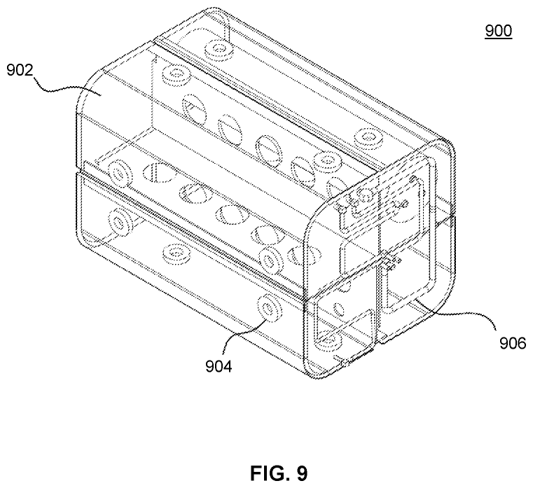

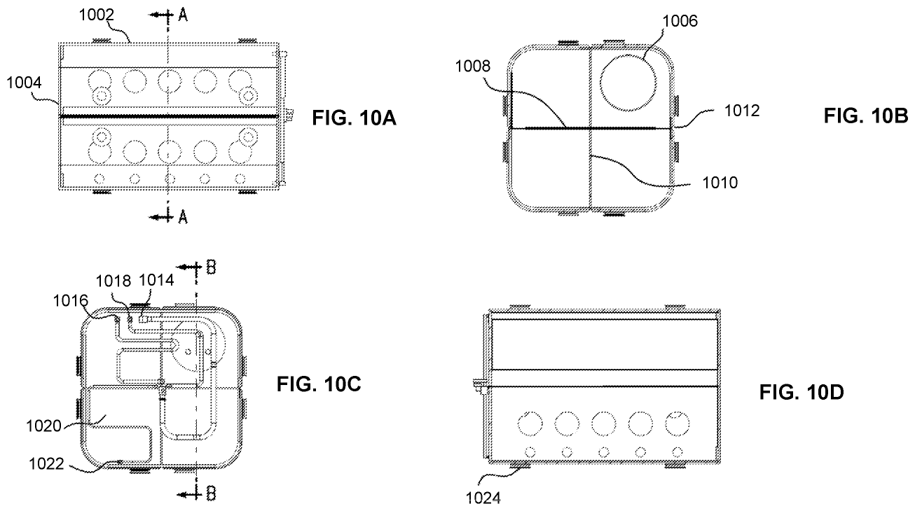

Referring now to FIG. 1A, a system 100 is provided according to some embodiments. The system may comprise a vaporizer 102 and heat exchanger 104, where a liquid is vaporized at stage 102 and the resultant gas is passed to the heat exchanger 104. The vaporizer 102 may be configured, for instance, as described with respect to FIGS. 1B, 3, 4A, and 4B. In embodiments, droplets of the input liquid are vaporized on heated plates of the vaporizer 102. The liquid may be provided from a storage 106 containing the process liquid. In embodiments, the storage 106 is a cryogenic tank and the input liquid is a cryogenic material, such as methane or hydrogen. According to embodiments, one or more of the storage tanks described in FIGS. 9 and 10A-10D may be used. Other configurations of storage tank may also be used.

In the example of FIG. 1A, system 100 is configured such that liquid flows (F1) to a liquid input of the vaporizer 102, and a heat source flows (F2) to a heat input of the vaporizer 102. The heat may be provided in liquid or gaseous form. The heating material may be provided from a source 114. For example, the heat source 114 may be engine coolant circulated from the engine or other waste heat (e.g., exhaust or other heated gas). Because ultimate control of output temperature in system 100 may be adjusted as needed, the heat source 114 may be variable.

The resultant gas (G1) from vaporization of the liquid then moves to the gas input of the heat exchanger 104. According to embodiments, the heat exchanger 104 can be of any type suitable for the application. In some examples, it is able to provide a warm enough stream so that the output is compatible with use on the engine without causing damage (e.g., so that it can be mixed with the cold stream to achieve the desired output temperature). In certain aspects, a first portion (G2) of the gas from the vaporizer passes to the input of the heat exchanger, while another portion (G4) of the gas from the vaporizer bypasses the heat exchanger 104. The gas input to the heat exchanger can be heated, for instance, using a source of heat (flow F_{A} from source 114) to generate a heated output gas G3. According to embodiments, all of the gas from the vaporizer 102 is passed to the heat exchanger 104 and heated. However, in some embodiments, only a portion (or none) of the gas is heated. In some embodiments, all of the gas from the vaporizer 102 may bypass the heat exchanger 104. Additionally, and in some embodiments, the heated portion of the gas (G3) can be re-combined with the stream of gas (G4) from the vaporizer to form a mixed gas (Gₘᵢₓ), which is then passed to a destination 108, such as an engine or container. In this respect, the temperature of the gas (Gₘᵢₓ) can be controlled through the ratio of heated/non-heated gas in the mixture. This can de-couple the output temperature from the specific performance of the heat exchanger or the temperature of heat source 114, which may be variable.

In some embodiments, temperature controlled or mixed gas is provided to a compressor. For example, destination 108 may be a compressor, secondary system with a compressor, or engine with compressor. In certain aspects, the temperature and/or flow rate of the system output gas (e.g., Gₘᵢₓ) can be controlled for optimized compressor performance. This can, for instance, minimize parasitic power loss to the compressor by ensuring that its flow rate is optimal. Where the compressor is a vane compressor, correct control of temperature and/or flow can be achieved by regulating the compressor speed. The destination 108 may also be a buffer in some embodiments.

According to embodiments, a single source 114 may provide heat to both the vaporizer 102 and heat exchanger 104. Additionally, the same stream of heated materials may provide the heat to both stages, for instance, where the heat source flows (F2) to the input of the vaporizer 102, flows from the output (F3) of the vaporizer 102 to the input (F_{A}) of the heat exchanger 104, and flows from the output (F_{B}) of the heat exchanger. In certain aspects, the heat output of the vaporizer is coupled 140 to the heat input of the heat exchanger (e.g., coolant flows via hose through the system 100). However, in some embodiments, the heat sources of the vaporizer 102 and heat exchanger 104 may be separate. For example, the vaporizer may use a source 114a and return 114b, while the heat exchanger may use a source 114c and return 114d. That is, two heat exchange circuits may be implemented in system 100.

The flow and/or temperature of liquid and gases in the system 100 may be controlled by one or more valves 112. For instance, a valve 112a may be used to control flow from the container 106 to the input of vaporizer 102. As another example, a valve 112b may be used to control the flow of gas (G2, G4) to the heat exchanger 104, or to bypass the heat exchanger. Additional valves 112c and 112d may be included along the respective flow paths for additional control over the mixing (e.g., at a t-junction before the output). Though not shown, there may also be gas or fluid control valves to control the flow of materials to and from the heat source(s) 114. While valves are used as an example, flow control elements 112 may be implemented that include on/off solenoids, manual valves, proportional controllers, orifice plates, etc.

Control over the process, including valve control, may be provided by a control device 110. For example, a controller 110 may be in communication with a temperature sensor 118 to monitor the temperature of the output gas mixture. Sensor 118 may be additionally, or alternatively, a flow sensor. Moreover, the controller may receive signals from the destination 108, such as information regarding engine performance or demand, or storage container status. Based on this information, the controller can perform the necessary control tasks. For instance, it can increase or decrease the flow of liquid from container 106 to the vaporizer 102. This may be based, in some embodiments, on the needs of an engine or if a storage tank at the destination 108 is full or empty. As another example, the controller 110 can adjust the ratio of gases G2, G3, G4 to adjust temperature. For instance, if an output temperature is too low, the controller can increase the relative amount of gas from the vaporizer 102 that flows to the heat exchanger 104. Conversely, if the temperature is too high, the controller can increase the relative amount of gas from the vaporizer that bypasses the heat exchanger (i.e., stays relatively cold). In this respect, temperature of the output gas can be precisely controlled without modifying the performance/settings of the heat exchanger 104 itself or adjusting the heat source 114. One or more components shown in FIG. 1A may be omitted according to embodiments.

According to embodiments, vaporization and temperature control can be performed using a system 150 as shown in FIG. 1B. In a first phase 160, a liquid is vaporized to a gas. In a second phase 170, the temperature of the gas is controlled. The second phase may further comprise delivery of the temperature-controlled gas to a target device or container, such as an engine for which the liquid/gas is a fuel or storage device. While fuel for an engine is used in the example of FIG. 1B and system 150, the same system and processes may be applied more generally for vaporization and/or temperature control of other materials and in different contexts.

With further reference to the example of FIG. 1B, a fuel enters the vaporizer. It may do so, for instance, in droplets and at a rate determined by the engine demand. When the fuel hits the plates in the vaporizer, the droplets bounce around and disintegrate yielding a very quick transition to the vapor phase. In this embodiment, partial and/or slotted discs (e.g., fins) are attached to a central pipe through which the engine coolant flows. In this example, the central pipe is in good thermal contact with the engine coolant. The fins are also in good thermal contact with the central pipe. The Leidenfrost effect means that the heat of vaporization required to vaporize the fuel is spread over many fins, considerably reducing the chance of cold spots forming. This arrangement will lead to a fast response to the engine demand, for example. The separation of the vaporizing aspects (e.g., in a first phase 160) and the temperature raising aspects (e.g., in a second phase 170) of the example allows for accurate control of the temperature of the fuel going to the engine. This can be desirable in some situations where a slightly colder fuel delivery can improve performance through enhanced throughput. In certain aspects, temperature control of the fuel delivery can lead to more consistent engine performance. Moreover, the arrangement of FIG. 1B can mean that the design of the heat exchanger may be simplified, since a control system can determine and/or adjust the output temperature (e.g., through operation of the control valves to achieve desired temperature via stream mixing). Information regarding temperature may be fed-back to a control element or valve from a temperature indicator (TI), such that the temperature is measured and the valve(s) adjusted to give the correct temperature and/or flow.

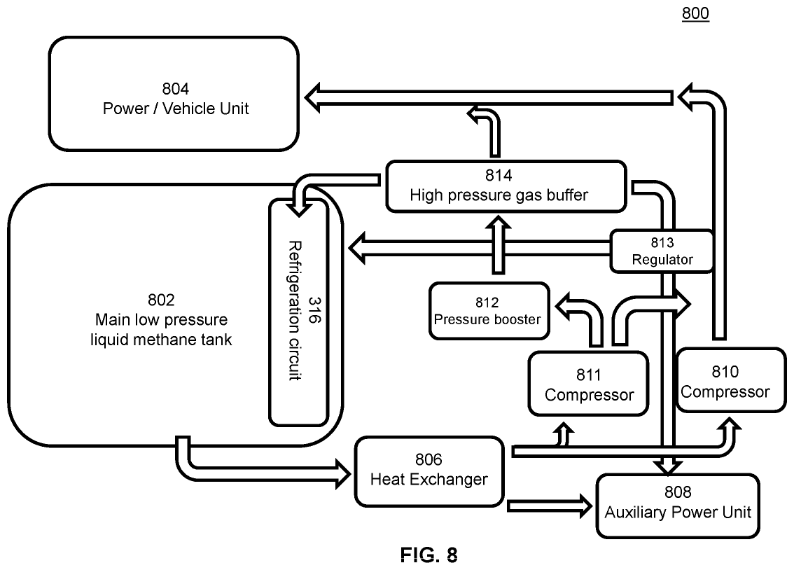

According to some embodiments, the devices and/or system of FIGS. 1A and 1B can be used as part of a fuel delivery system. An example of a fuel delivery system 800 is illustrated in FIG. 8. In certain aspects, one or more the embodiments described herein could be used, for example, in place of or in connection with heat exchanger 806 shown in FIG. 8. For example, a vaporizer 102 and/or heat exchanger 104 could generate gas (e.g., methane gas) using liquid from tank 802, including temperature-controlled gas as described in connection with FIGS. 1A and 1B. Likewise, one or more of the features described herein, such as the output of vaporizer 102 or heat exchanger 104, could be coupled to a compressor 810, 811, a gas buffer 814, and/or a power unit 804, such as an engine configured to operate from Gₘᵢₓ. A power unit, such as power unit 804, could operate using gas from the two-phase system illustrated and described in connection with FIG. 1B. As another example, destination 108 in FIG. 1A could be the power unit 804, a buffer, or one or more compressors 810, 811 as illustrated in FIG. 8. As another example, the liquid storage 106 in FIG. 1A could correspond to the tank 802 in FIG. 8. In some embodiments, the power unit 804 could provide the source of heat 114 in FIG. 1A. While the system 800 is used for these examples, according to embodiments, the devices and systems described herein could be used in other fuel delivery systems as well.

In the context of the use of cryogenic fuels for transport or power generation, there can be several difficulties in providing vapor to an engine at the correct temperature. For instance, the fuel may need to be evaporated and warmed to room temperature (or near to room temperature) so that the fuel injection or carburation system is not exposed to low temperatures that may damage the mechanism. Additionally, it may be difficult to control the temperature of the fuel to the engine without complex, bulky, or fault-prone components. Further, if heat exchange is not properly controlled, there may be issues surrounding icing of an engine coolant in a heat exchanger if used as a heat source. And more generally, icing can be a concern in any system using cryogenic materials. According to embodiments, the vaporizer of a system is a relatively compact device, and moreover, the size of the heat exchanger may be minimized. In addition, and in certain aspects, the heat exchanger only has to contend with a single phase on each of the hot and cold stream (e.g., gases on the cold stream and liquid on the hot stream). In this respect, a simple brazed plate heat exchanger may be used in some examples. Systems, devices, and processes described herein can alleviate one or more of the challenges associated with use or processing of cold materials.

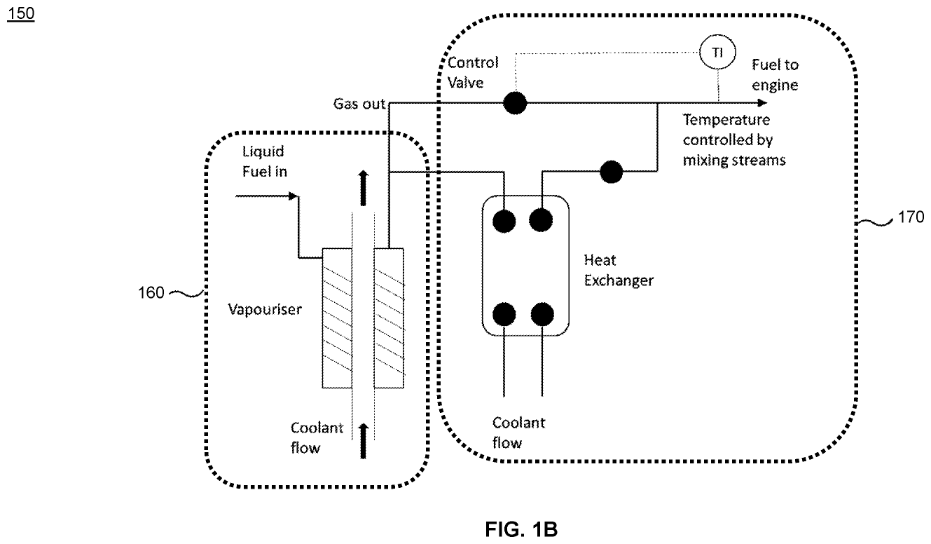

Certain benefits of embodiments can be illustrated by reference to FIGS. 2A and 2B.

In FIG. 2A, a single-stage vaporization and heating element 226 is provided in which a liquid input 222a is vaporized, heated, and output 222b from the device 226. A heating source (e.g., warm liquid or gas) is input 224a and output 224b from the device 226. With the implementation of such a system, there may be a large temperature difference between the heating source temperature (T_{H1, in}) and the temperature of the input liquid (T_{C1, in}). For instance, in an engine-based system using liquid methane, an engine coolant (e.g., used as the heat source) is typically in the region −10 C to 100 C and the cryogenic methane fuel would be at about −159 C (˜114K, depending on pressure). Additionally, there would also be a potentially significant difference between input temperature (T_{C1}, in or T_{H1, in}) and output temperature (T_{C2, out} and T_{H2, out}). In this example, the device 226 functions as a heat exchanger across 2-phases (liquid to gas), which may require complex equipment. Additionally, the output temperature T_{C2, out} may be directly responsive to T_{H1, in,} making the system dependent on the heat source and potentially inconsistent if the source varies. In some applications, a large temperature variation may be problematic. For instance, on the input, the input liquid can carry a large amount of cooling power, which under some conditions of high flow, can freeze the circulating warm liquid. In addition, in this region, the phase change can occur in the small diameter pipes leading to flow inconsistencies because of the two-phase flow.

With reference to FIG. 2B, a two-stage system is illustrated. In this example, the input liquid (at temperature T_{C1, in}) is vaporized in a first phase 260 using a heat source (at temperature T_{H1, in}). As part of this process, the output gas is at temperature T_{C′}, and the heat source material (e.g., engine coolant) moves out of the device at a new temperature T_{H′}, out. The gas can then move to the heat exchange phase 270, where it is raised to a second temperature T_{C2, out} with a heat source at T_{h′, in} that is then modified to temperature T_{H2, out} at the output of stage 270 via the heat exchange process. In some embodiments, after the vaporizer, the temperature of the process gas is close to the liquid temperature. However, all of the latent heat has been removed and the process gas is single phase. This means that its ability to freeze the heat source material (e.g. engine coolant) is significantly reduced. The temperature of the gas to the engine can be closely controlled reducing the possibility of damage (e.g. to seals). In some embodiments it may be preferable to have a cold input to the engine to take advantage of higher mass flow due to lower pressure drops in pipe work or entrance valves. Other advantages may occur if a compressor is used to raise the pressure of the process gas. In this case there would be advantage in compressing a cold gas but too low a temperature may cause issues with the lubrication system. In some embodiments, during operation, the exit temperature will be similar to the entrance temperature except that the liquid will have been turned into a gas. In certain aspects, the same heat source may optionally be re-used in both stages.

According to embodiments, one application of the systems, devices, and methods described herein is for Cryogenic Liquid Air Energy Storage (CLAES) systems where air (or any other gas) is liquefied using off-peak electricity. During times of high electricity demand, the liquid is boiled off using waste heat and put through a turbine or other such device to generate electricity. In this case a heat exchanger after the vaporizer can be used to generate high temperature gas. One application is to store methane in liquid form and generate gaseous methane at the correct temperature for use in an engine. The engine could be used for transport or electricity generation or to do other useful work. Another application could be with liquid hydrogen with a similar application as for the methane above.

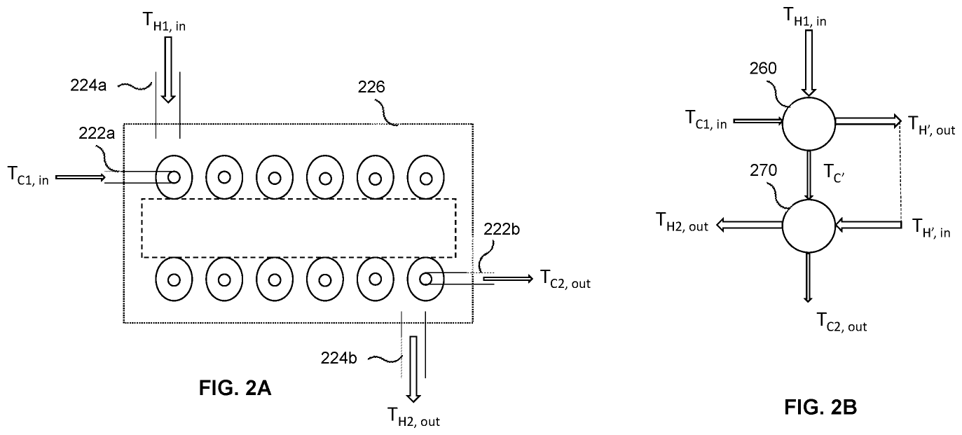

Referring now to FIG. 3, a vaporizer 300 is illustrated according to embodiments. The device may be used, for instance, as vaporizer 102 in system 100 of FIG. 1A, or as part of the first stage 160 in the system shown in FIGS. 1B, 2A, and 2B.

In this example, the device 300 comprises a liquid input 332, a gas output 336, and one or more plates 338. The plates 338 are arranged to receive liquid from the input 332. For instance, the plates 338 can be configured to receive liquid (e.g., cryogenically stored methane) from the liquid input 332 and generate gas by vaporizing the liquid, such that the generated gas exits the device via the gas output 336. According to embodiments, the output 336 may be a vent (e.g., comprising a one-way valve to prevent air ingress at the output). In certain aspects, the device 300 generates droplets of the liquid. The droplets may be formed, for example, either by a small nozzle at the input 332 or by the liquid stream from the liquid input 332 hitting the first of the plates 338, where the rapid expansion of the liquid hitting the first plate will generate highly mobile droplets which rapidly move down the plates 338 of vaporizer 300. In some embodiments, the plates 338 receive the liquid in droplet form. The plates 338 are preferably made of metal, but other materials with good heat conduction properties can be used. For example, any material can be used where the plates/fins/spiral 338 conduct heat from the center (e.g., from a through-pipe) to the edges. Optimum thickness for the plates can be calculated to maintain their temperature above the Leidenfrost point. In certain aspects, the device 300 is dimensioned such that the gas exiting the vaporizer at output 336 does not inhibit the liquid flow at input 332.

According to embodiments, the device 300 comprise a conduit 334, such as a pipe carrying a fluid that can act as a heat source for vaporization. The conduit 334 could carry, for instance, engine coolant. The one or more plates 338 can be mounted on, or otherwise physically attached to, the conduit or heat source (e.g., mounted radially about the conduit). In this respect, the one or more plates 338 can be in good thermal contact with the conduit or heat source in order to heat the plates. In some embodiments, the temperature difference of the coolant (or other heat source) and plates is higher than the Leidenfrost point on the boiling curve so the droplets of liquid are highly mobile on the plates 338. This could apply, for instance, to the difference in temperature between the coolant flow in a vehicle and the temperature of the incoming cryogenic liquid.

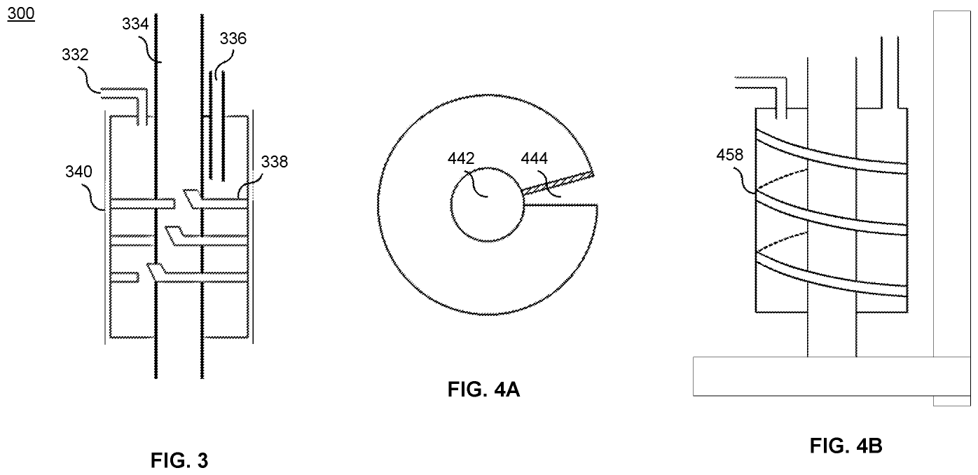

According to embodiments, the vaporizer 300 may comprise a plurality of annular slotted discs attached and in good thermal contact to the central pipe. While only three fins are shown for clarity in the illustration of FIG. 3, other arrangements, including a spiral arrangement of the fins could be used. Additional examples of the shape/arrangement of the plates 338 are provided in FIGS. 4A and 4B. As shown in FIG. 4A, the plates can be annular discs. In some embodiments, they may be slotted 444. With a ring-shaped arrangement, they may be easily mounted at their center 442 to the central conduit or other heat source. As shown in FIG. 4B, the one or more plates 338 may also have a corkscrew or spiral configuration 458. This may, for instance, promote movement of liquid droplets.

Additionally, the outside of the device 300 can be insulated 340 to prevent ice formation and protect from cold burns. In some embodiments, the insulation 340 covers the majority of the external surface of the device 300.

According to embodiments, system 100 may further include one or more processing and control components, such as apparatus 500. Such processing and control components can be used to monitor system status (e.g., flow rate or temperature), receive signals (e.g., from an engine or storage element), and control one or more valves or other flow control devices to adjust system output and temperature. In embodiments, one or more steps of process 600 or 700 may be responsive to or otherwise based on such monitoring and/or communications, including demand signaling from an engine or vehicle user, as examples.

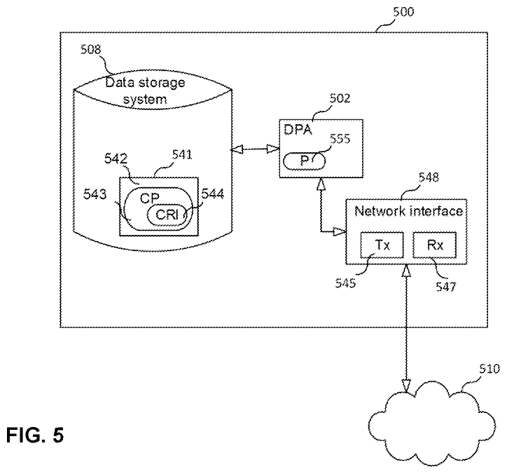

Referring now to FIG. 5, a block diagram of an apparatus 500, such as controller, is provided according to some embodiments. The apparatus 500 may be used, for example, as control device 110 of system 100 or 150, as illustrated in FIGS. 1A and 1B.

As shown in FIG. 5, the apparatus may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like); a network interface 548 comprising a transmitter (Tx) 545 and a receiver (Rx) 547 for enabling the apparatus to transmit data to and receive data from other nodes connected to a network 510 (e.g., an Internet Protocol (IP) network) to which network interface 548 is connected; and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes the apparatus to perform steps described herein (e.g., steps described herein with reference to the flow charts). In other embodiments, the apparatus may be configured to perform steps described herein without the need for code. That is, for example, PC 502 may consist merely of one or more ASICs. Hence, the features of the embodiments described herein may be implemented in hardware and/or software.

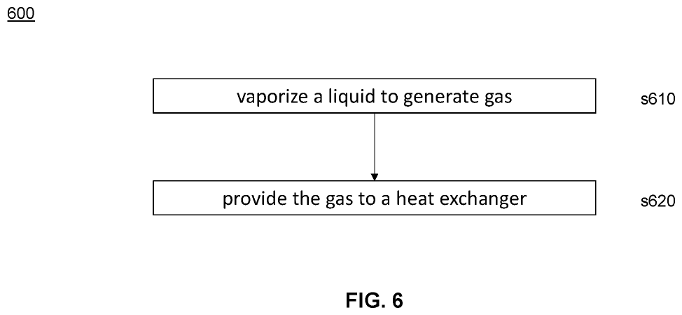

Referring now to FIG. 6, a method 600 for gas processing is provided according to embodiments. The method may be used, for instance, for processing of a fuel. According to embodiments, the method 600 may use the systems and/or device illustrated with respect to FIGS. 1A, 1B, 2B, 3, 4A, 4B, 8, 9, and 10A-10D. The method may comprise vaporizing a liquid to generate a gas (step s610), and then proving the gas to a heat exchanger (step s620).

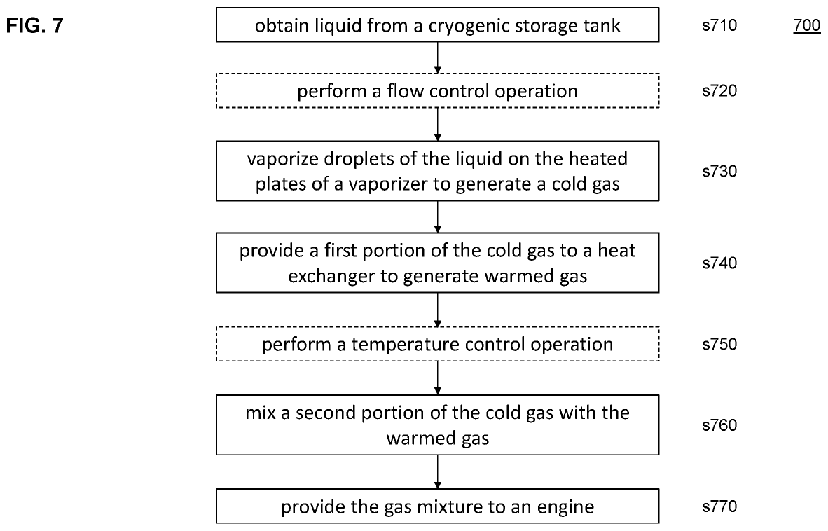

Referring now to FIG. 7, a method 700 for gas processing is provided according to embodiments. The method may be used, for instance, for processing and delivery of a fuel. According to embodiments, the method 700 may use the systems and/or device illustrated with respect to FIGS. 1A, 1B, 2B, 3, 4A, 4B, 8, 9, and 10A-10D. The method 700 may begin, in some embodiments, with obtaining (s710) a liquid from a cryogenic storage tank. In step s720, which may be optional in some embodiments, a flow control operation is performed. This could include, for instance, adjusting the flow of the cryogenic material to a vaporizer. In step s730, droplets of the liquid are vaporized on heated plates of the vaporizer to generate a cold gas. In step s740, a first portion of the cold gas is provided to a heat exchanger to generate warm gas. In certain aspects, the portion may be all, or less than all, of the gas from the vaporizer. In step s750, which may be optional in some embodiments, a temperature control operation may be performed. This could include, for example, adjusting the relative flow (i.e., the portion) of the gas to the heat exchanger. In step s760, the warmed gas is mixed with a remaining portion of the cold gas from the vaporizer. In step s770, the gas mixture (e.g., at a desired temperature) is provided to an engine. While fuel delivery to an engine is used as an example, processing of other fuels or other materials may be performed in the same manner. For instance, the output may simply be storage or further processing of the temperature-controlled gas.

Referring now to FIG. 8, a system 800 for the storage and delivery of a fuel, for instance methane, is provided according to some embodiments. The system may comprise a low pressure fuel storage tank 802. In some embodiments, tank 802 has a non-cylindrical cross-section, such as a square or rounded rectangular cross-section. Although square and rounded rectangle shapes are used in this example, other non-cylindrical cross-sections could be used. Additionally, the tank 802 could have a complex shape, for instance, an “L” shape. The system may also include a heat exchanger 806, an auxiliary power unit 808, a liquefaction/refrigeration circuit 816, a gas compressor 810, and a high pressure buffer and booster 814 and 812. In some embodiments, the system includes a vaporization device, for instance, coupled to heat exchanger 806.

In some embodiments, upon receiving a demand for gaseous methane, the compressor 810 is powered up, forcing gas into the engine 804. Gas may also be forced back into the tank via a regulator, pressurizing the tank to force more liquid methane out through the heat exchanger 806, where it has been vaporized before being compressed and forced into the engine to continue the cycle. That is, gas may be passed to the tank 802 from compressor 810 (or 811) via regulator 813. In this way, the components of system 800 may be used in conjunction to simultaneously deliver the necessary fuel to unit 804 (e.g., an engine) while ensuring that additional fuel will be vented from tank 802 for sustained delivery and use.

According to some embodiments, a second compressor 811 may be used. The second compressor can be coupled to the tank 802. In some embodiments, the second compressor 811 is placed in parallel with the first compressor 810 to deliver methane gas under high demand. In some embodiments, the second compressor 811 may be arranged to act independently of the first compressor 810 to supply methane gas to a pressure booster, such as booster 812. This may be, for instance, to achieve high pressure for storage in the high pressure buffer 814 or to drive a cooling unit, such as refrigeration circuit 816. As illustrated in FIG. 8, and in some cases, regulator 813 may be further connected to compressor 811 and used to direct gas to one or more of buffer 814 and tank 802. Although depicted as a single component, in some instance, regulator 813 may comprise a plurality of regulation components, including one or more valves. According to some embodiments, the first and second compressors 810, 811 can be located anywhere on the vehicle serviced by the necessary pipework, control, and power cables. In some instances, one or more of the compressors takes gas at low pressure, for example, 3 bar, and delivers it to an engine at higher pressure, such as 10 bar. This could be, in some embodiments, with a combined output rate of 16 grams per second. According to embodiments, one or more of compressors 810, 811 may not be required.

By way of example, during normal vehicle cruising operation one compressor (e.g., compressor 810) could be sufficient to deliver methane at a first level, such as at 8 grams per second to the engine. In this instance, the second compressor could be reserved for additional tasks, as required. As an example, the second compressor (e.g., 811) could be used to supply gas to a pressure booster and/or fill a high pressure buffer. According to some embodiments, when there is a need to cool a fuel stored in a tank, such as liquid methane in tank 802, high pressure methane from the buffer or from the output of a pressure booster can be passed through a refrigeration element, such as a Joule Thompson refrigeration circuit inside the tank, re-condensing the methane to a liquid that is colder than the main reservoir. This could increase the hold time left before the methane would need to be vented, or make additional space available for fresh fuel because the colder methane is denser.

According to some embodiments, initial start-up of a vehicle, including for instance starting power/vehicle unit 804, can be achieved using fuel stored in a high pressure buffer, such as buffer 814, which can store methane gas. This could allow, for example, the first compressor 810 to start independently of the pressure in the main tank 802, which may be low according to some embodiments. In certain aspects, once the compressor 810 is running, a regulator 813 can be used to bleed some gas into the main tank. In some embodiments, gas is bled to the main tank 802 at 3 bar. In some respects, the main tank pressure is therefore set independently of the liquid methane vapor pressure. According to embodiments, for instance in situations that require high gas flow, a pressure raising circuit can be incorporated. This can enable the pressure of the tank to be increased by boiling off some of the liquid, for example through a heat exchanger attached to the inside wall of an outer vacuum vessel. In this way, pressure in the tank can be maintained during periods of high usage

In certain aspects, auxiliary power unit 808 can serve a number of roles. According to embodiments, it can be positioned anywhere on a vehicle and connected via the necessary pipes. It can be used to extract energy from the methane gas that would otherwise have to be vented when the pressure in the methane tank is rising but the vehicle or generator is not being used. Electrical energy may be generated by unit 808, for instance, with a fuel cell arrangement and/or a secondary combustion engine by using some of the methane. The electrical energy can be stored in a battery.

According to some embodiments, auxiliary power unit 808 can be also be used to provide power and/or heat to a vehicle's quarters, including for instance a cabin or “hotel’ load when the driver is sleeping overnight. For very cold starts, for example, it can be run exclusively from the high pressure buffer to generate heat for the heat exchanger and/or vaporizer to vaporize liquid methane before the vehicles main engine is sufficiently warm. In some embodiments, an auxiliary power unit may provide a source of heat as described in connection with FIGS. 1A and 1B.

According to some embodiments, system 800 may operate in a state in which a tank is at an increased pressure. For example, they system may operate when the storage tank 802 has been left for a period of time allowing heat to boil the stored fuel, such as liquid methane, thereby increasing the pressure. According to embodiments, a valve is opened for feeding the excess methane gas to an auxiliary power unit (such as a combustion engine or fuel cell) where power is generated and stored in a battery. This could be unit 808, for instance. Power from the battery can then be used to power a compressor to take excess gas from the tank and pass it through a pressure booster (e.g., booster 812) and cooling unit (e.g., refrigeration circuit 816) to re-liquefy excess gas and return it to the main reservoir. This can advantageously reduce the main reservoir's temperature and extend its non-venting storage time. Alternatively, and according to some embodiments, a compressor and booster can be used to take low pressure gas from the main tank and store it in a highly compressed gaseous state in a high pressure buffer, such as buffer 814, that acts as an independent reservoir that can be used to initiate the starting sequence of the main engine or supply the auxiliary power unit as required.

Although one larger low pressure compressor could be used, according to some embodiments, to supply sufficient gas to the engine when under maximum demand the use of two lower flow compressors acting independently may be used. In some cases, under normal operation, one compressor can fulfil the sufficient fuel delivery saving energy. Further, to provide a high pressure buffer volume the second compressor can be used independently. By pumping gas through a pressure booster a high pressure reservoir can be filled. This can then be used to either power the engine during a cold start or keep the liquid reservoir cold by passing through a Joule Thompson refrigeration system positioned within the inner liquid methane tank. This system can be used to keep the main reservoir cold, thereby sustaining low pressure operation. In some embodiments, the gas provided to the power unit 804, one or more compressors 810, 811, and/or a storage such as buffer 814 may be temperature controlled as described with respect to FIGS. 1A and 1B.

Referring now to FIG. 9, aspects of a storage tank 900 are provided according to some embodiments, such as an inner storage vessel. The vessel may include an outer surface 902, one or more connection points, 904, for instance, for a suspension system, and piping 906. FIGS. 10A-10C provide detailed views of aspects of a storage tank, according to some embodiments. In this example, 1002 is a rounded section and 1004 is an end plate, rear side. FIG. 10B is a cross-section taken along “A” of FIG. 10A. As shown in the example of FIG. 10B, 1006 is a ullage cylinder, 1008 is a horizontal reinforcement, 1010 is a vertical reinforcement, 1012 identifies flanges, 1014 is a fill line, 1016 is vent line, 1018 is a gas line, 1020 is an end plate, side, and 1022 is a liquid line. FIG. 10D is a cross-section taken along “B” of FIG. 10C. A connection point 1024 is illustrated, which may be, for example, a capstan. In some embodiments, the capstans are positioned in the same dimension on each side. While connection points 1024 are used as an example, other suspension systems may be used according to embodiments for a storage tank, including to suspend an inner vessel within an outer vessel.

### Summary of Embodiments

A1. A vaporization device, comprising: a liquid input; a gas output; and one or more plates arranged below the liquid input.
A2. The device of A1, wherein the one or more plates are configured to receive liquid from the liquid input and generate gas by vaporizing the liquid, and wherein the generated gas exits the device via the gas output (e.g., a vent comprising one-way valve to prevent air ingress at the output).
A3. The device of Al or A2, wherein the liquid input is configured to generate droplets of liquid (e.g., formed either by a small nozzle or by the liquid stream from the liquid input hitting the first plate, where the rapid expansion of the liquid hitting the first plate will generate highly mobile droplets which rapidly move down the vaporizer), and/or wherein the plates receive the liquid in droplet form.
A4. The device of any of A1-A3, further comprising: a conduit (e.g., a pipe carrying a fluid such as engine coolant) or other heat source.
A5. The device of A4, wherein the one or more plates are mounted on (or otherwise physically attached to) the conduit or heat source.
A6. The device of A4 or A5, wherein the one or more plates are in thermal contact with the conduit or heat source.

The device of any of A1-A6, wherein the one or more plates are a plurality of plates (e.g., three or more).
A8. The device of any of A4-A7, wherein the conduit (or other heat source) is arranged centrally in the device and/or runs lengthwise through the device.
A9. The device of any of A4-A8, wherein each of the plurality of plates are a disc or fin (e.g., a perforated disc or fin) mounted radially about the conduit (or other heat source).
A10. The device of any of A1-A9, wherein at least one of the plates is an annular slotted disc (e.g., comprising annular slotted plates arranged in a spiral to promote movement of the liquid droplets).
A11. The device of any of A1-A6, wherein the at least one plate comprises a single plate (or multiple plates) arranged about a central conduit in a corkscrew or elongated spiral arrangement.
A12. The device of any of A1-A11, wherein the at least one plate is comprised of metal.
A13. The device of any of A1-A12, further comprising: an insulating layer arranged on an exterior surface (e.g., covering the majority of the exterior surface) of the vaporization device.
A14. The device of any of A1-A13, wherein the at least one plate is heated (e.g., such that the temperature difference between the incoming liquid and the temperature of the fin/plate/spiral needs to be above the Leidenfrost point).
A15. The device of any of A1-A14, wherein the device is configured such that liquid enters the device at a first temperature (T_{C1, in}) and gas exits the device at a second temperature (T_{C2, out}), wherein the second temperature is greater than the first temperature.
A16. The device of A15, wherein the conduit (or heat source) has a third temperature (or contains a fluid having a third temperature), and wherein the third temperature is greater than both the first and second temperatures.

B1. A device comprising: an input; a central conduit; and vaporization means for generating an output gas from liquid received from the input, wherein the vaporization means are mounted on the central conduit and configured to receive heat from the central conduit.
B2. The device of B1, further comprising: an output for the generated gas.
C1. A system, comprising: a vaporizer; and a heat exchanger, wherein a first input of the heat exchanger is coupled to the output of the vaporizer.
C2. The system of C1, wherein the vaporizer is a device according to any of A1-A16 or B1-B2 and the first input of the heat exchanger is configured to receive gas output from the vaporizer.
C3. The system of C1 or C2, further comprising: a container of process liquid connected to a first input of the vaporizer.
C4. The system of C3, wherein the liquid container is a cryogenic storage tank (e.g., for methane).
C5. The system of any of C1-C4, further comprising: a first heat source coupled to a second input of the vaporizer (e.g., the conduit).
C6. The system of C5, further comprising: a second heat source coupled to a second input of the heat exchanger.
C7. The system of C6, wherein the first and second heat source are the same (e.g., the coolant of an engine)
C8. The system of any of C1-C7, further comprising: at least one flow control valve (or other flow control element).
C9. The system of C8, wherein the at least one control valve comprises one or more of:
   (i) a valve to control the flow of process liquid from the liquid container to the vaporizer;
   (ii) one or more valves to control the flow of gas from the vaporizer to the heat exchanger and/or system output (e.g., to an engine); or
   (iii) a valve to control the flow of gas from the heat exchanger.
C10. The system of any of C1-C9, further comprising: at least one temperature sensor (e.g., to sense the temperature of gas at the output of the system (e.g., to an engine)) and/or flow sensor.
C11. The system of any of C1-C10, further comprising: a controller.
C12. The system of C11, wherein the controller is figured to perform one or more of the following:
   (i) control the flow of liquid (e.g., fuel) from the liquid container (e.g., storage tank) to the vaporizer;
   (ii) control the rate of droplet formation;
   (iii) control the flow of output gases from the vaporizer and/or heat exchanger (e.g., to achieve a desired temperature at an output of the system);
   (iv) monitor temperature (e.g., of mixed gas to an engine);
   (v) monitor the temperature and/or flow of gas to a compressor (e.g., for optimized performance);
   (vi) receive signals regarding gas flow and/or demand (e.g., from an engine or vehicle user, or a sensor.
C13. The system of C12, wherein one or more of the flow of liquid or control of output gases is based at least in part on a demand signal from an engine or a signal from a sensor indicating a gas temperature (or flow) at an output of the system.
C14. The system of any of C1-C13, further comprising: an engine (e.g., internal or external combustion engine).
C15. The system of C14, wherein the engine is arranged to receive a mixture of gas from the vaporizer and gas from the heat exchanger.
C16. The system of any of C1-C15, further comprising: a compressor or buffer.
C17. The system of C1, wherein the compressor or buffer is arranged to receive a mixture of gas from the vaporizer and gas from the heat exchanger.
D1. A fuel delivery system in a vehicle using any of C1-C17.
D2. The system of D1, wherein coolant flows (e.g., via one or more hoses) from an engine to the vaporizer and heat exchanger to provide a source of heat and the temperature-controlled gas is passed to the engine.
E1. A vehicle comprising any of embodiments A, B, C, or D.
E2. The vehicle of E1, wherein the fuel for the vehicle is stored as a cryogenic liquid in a vehicle-mounted tank.
F1. A method of using any of embodiments A, B, C, D, or E.
F2. A method of assembling any of embodiments A, B, C, D, or E.
G1. A gas processing (or fuel delivery) method, comprising: vaporizing a liquid to generate a first gas; and providing at least a first portion of the generated first gas to the input of a heat exchanger to form heated gas.
G2. The method of G1, further comprising: mixing a second portion of the generated first gas with the heated gas to form a mixed gas.
G3. The method of G2, further comprising: providing the mixed gas to an engine as fuel (or to a compressor, or to a container or buffer).
G4. The method of any of G1-G3, wherein the liquid is methane obtained from a cryogenic storage tank.
G5. The method of any of G1-G4, wherein the liquid is vaporized using a vaporizer comprising one or more plates (e.g., as in Embodiment A or B), and wherein the vaporizing comprising: providing droplets of the liquid to an upper surface of at least one of the plates.
G6. The method of G5, further comprising: heating the at least one plate.
G7. The method of G6, wherein the at least one plate is heated using coolant from the engine (e.g., wherein the plate is thermally mounted to a pipe or hose in the vaporizer in which engine coolant is flowing).
G8. The method of any of G1-G7, wherein the first portion of the generated first gas is warmed in the heat exchanger using coolant from the engine (e.g., engine coolant is flowed to/through the heat exchanger).
G9. The method any of G2-G8, further comprising: receiving, at a controller, a signal from a sensor indicating the temperature (and/or flow rate) of the mixed gas.
G10. The method of G9, further comprising: controlling (e.g., opening or closing) one or more gas flow valves to control the temperature of the mixed gas based at least in part on the received signal.
G11. The method of G10, comprising: reducing the portion of the generated first gas that is provided to the input of the heat exchanger when the signal indicates that the temperature is too high; and increasing the portion of the generated first gas that is provided to the input of the heat exchanger when the signal indicates that the temperature is too low.
G12. The method any of G3-G11, further comprising: receiving, at a controller, a signal indicating a demand for fuel to the engine; and increasing or decreasing a flow of liquid to the vaporizer (or rate of droplet formation) based at least in part on the signal.
G13. The method of G12, wherein the flow of liquid is adjusted using one or more valves (e.g., to adjust the rate of droplets to the plates of the vaporizer).
H1. A method of operating a vehicle, comprising performing any of G1-G13.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-40. (canceled)

41. A vaporization device, comprising:
a liquid input;
a gas output; and
one or more plates arranged below the liquid input,
wherein the one or more plates are configured to receive liquid from the liquid input and generate gas by vaporizing the liquid, and
wherein the generated gas exits the device via the gas output.

42. The device of claim 41,
wherein the liquid input is configured to generate droplets of liquid.

43. The device of claim 41, wherein the plates are configured to receive the liquid in droplet form.

44. The device of claim 41, further comprising:
a heat source, wherein the one or more plates are attached to the heat source.

45. The device of claim 44, wherein the heat source is a fluid conduit.

46. The device claim 45, wherein the fluid conduit is a pipe carrying engine coolant.

47. The device of claim 41, wherein the one or more plates comprise a plurality of plates.

48. The device of claim 47, wherein each of the plurality of plates is a disc or fin mounted radially about a heat source.

49. The device of claim 44, wherein the heat source is arranged centrally in the device and runs lengthwise through the device.

50. The device of claim 41, wherein at least one of the plates is an annular slotted or perforated disc.

51. The device of claim 41, wherein the at least one plate comprises a single plate arranged about a central conduit in a corkscrew or elongated spiral arrangement.

52. The device of claim 41, further comprising:
an insulating layer arranged on an exterior surface of the vaporization device.

53. The device of claim 41, wherein the one or more plates are heated.

54. The device of claim 44,
wherein the device is configured such that liquid enters the device at a first temperature (T_{C1, in}) and gas exits the device at a second temperature (T_{C2, out}), wherein the second temperature is greater than the first temperature,
wherein the heat source has a third temperature or contains a fluid having a third temperature, and
wherein the third temperature is greater than both the first and second temperatures.

55. A system, comprising:
a vaporization device; and
a heat exchanger,
wherein the vaporization device comprises:
a liquid input,
a gas output, and
one or more plates arranged below the liquid input,
wherein the one or more plates are configured to receive liquid from the liquid input and generate gas by vaporizing the liquid, and
wherein a first input of the heat exchanger is coupled to the gas output and configured to receive the generated gas.

56. The system of claim 55, further comprising:
a container of process liquid connected to a first input of the vaporization device.

57. The system of claim 55, further comprising:
an engine,
wherein the engine is arranged to receive a mixture of gas generated from the vaporization device and gas from the heat exchanger.

58. The system of claim 55, further comprising:
a compressor or buffer,
wherein the compressor or buffer is arranged to receive a mixture of gas generated from the vaporization device and gas from the heat exchanger.

59. A vehicle, comprising:
an engine; and
a fuel delivery system, wherein the fuel delivery system comprises a heat exchanger and a vaporization device according to claim 41.

60. The vehicle of 59, wherein the vehicle is configured such that coolant flows from the engine to the vaporization device and heat exchanger of the fuel delivery system, and wherein a temperature-controlled gas is passed to the engine from one or more of the heat exchanger or vaporization device.
